(19) United States
(12) Patent Application Publication
(10) Pub. No.: US 2025/0314822 A1
(43) Pub. Date: Oct. 9, 2025

(54) Structure and Method of an Integrated Circuit Having Silicon Photonic Integration

(71) Applicant: Taiwan Semiconductor Manufacturing Company, Ltd., Hsin-Chu (TW)

(72) Inventors: Chen-Hua YU, Hsinchu (TW); Jiun Yi WU, Taoyuan County (TW)

(21) Appl. No.: 18/627,686

(22) Filed: Apr. 5, 2024

(51) Int. Cl. G02B 6/124; G02B 6/13

(52) U.S. Cl. CPC G02B 6/124; G02B 6/13

(57) ABSTRACT

The present disclosure provides a semiconductor device that comprises a first integrated circuit die disposed over a substrate; and a second integrated circuit die coupled with the first integrated circuit die and disposed over the substrate. The first integrated circuit die comprises an optical lens of a transparent material to receive light, and a seal ring structure surrounding the optical lens.

The semiconductor integrated circuit (IC) industry has experienced exponential growth. Technological advances in IC materials and design have produced generations of ICs where each generation has smaller and more complex circuits than the previous generation. In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of IC processing and manufacturing, and other challenges for these advancements to be realized, such as metal corrosion and delamination an in integrated structure having photonic module. Accordingly, it would be desirable to provide an IC structure and a method of manufacturing thereof to address these issues.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a sectional view of an integrated circuit (IC) structure, constructed according to some embodiments of the present disclosure;

FIG. 2 is a sectional view of an IC structure, constructed according to some embodiments of the present disclosure;

FIGS. 3A and 3B are sectional views of an IC structure at various fabrication stages, constructed according to some embodiments of the present disclosure;

FIG. 4 is a flowchart of a method making an IC structure, constructed according to some embodiments of the present disclosure;

FIGS. 5 and 6 are sectional views of an IC structure, constructed according to some embodiments of the present disclosure;

FIGS. 7, 8 and 9 are a sectional view and top views, respectively, of an IC structure, constructed according to some embodiments of the present disclosure;

FIGS. 10 and 11 are top views of an IC structure, constructed according to various embodiments of the present disclosure; and

FIGS. 12, 13, 14 and 15 are sectional views of an IC structure, constructed according to some embodiments of the present disclosure.

### DETAILED DESCRIPTION

The following disclosure provides many different embodiments, or examples, for implementing different features. Reference numerals and/or letters may be repeated in the various examples described herein. This repetition is for the purpose of simplicity and clarity and does not in itself dictate a relationship between the various disclosed embodiments and/or configurations. Further, specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. Moreover, the formation of a feature on, connected to, and/or coupled to another feature in the present disclosure may include embodiments in which the features are formed in direct contact, and may also include embodiments in which additional features may be formed interposing the features, such that the features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact. In addition, spatially relative terms, for example, “lower,” “upper,” “horizontal,” “vertical,” “above,” “over,” “below,” “beneath,” “up,” “down,” “top,” “bottom,” etc. as well as derivatives thereof (e.g., “horizontally,” “downwardly,” “upwardly,” etc.) are used for ease of the present disclosure of one feature relationship to another feature. The spatially relative terms are intended to cover different orientations of the device including the features. Still further, when a number or a range of numbers is described with “about,” “approximate,” and the like, the term is intended to encompass numbers that are within a reasonable range including the number described, such as within +/−10% of the number described, or other values as understood by person skilled in the art. For example, the term “about 5 nm” encompasses the dimension range from 4.5 nm to 5.5 nm.

The present disclosure relates generally to an integrated circuit (IC) structure and a method making the same, and more particularly, to an integrated circuit structure having both electronic die (or electronic chip or electronic integrated circuit) and a photonic die (or photonic chip or photonic integrated circuit) formed in a same packaging. The structure and the corresponding technologies are also referred to as silicon photonic (SiPho) integration or co-packaging optics (CPO). In the disclosed structure and the method making the same, the electronic die and the photonic die are formed on a same substrate and co-packaged in a three-dimensional (3D) IC structure, such as chip-on-wafer (COW), chip-on-wafer-on-substrate (CoWoS), and other suitable 3D structure.

As the bandwidth and power density limit of data transport in electrical wires are increasingly manifesting with higher integration density, integrated optical scenarios have shown promising inroads towards ultrafast and broadband information processing with low power consumption that can circumvent current electrical bottleneck. However, existing structure suffers inner metal corrosion or dielectric-to-metal delamination risk during post etch process. The disclosed IC structure will effectively address those concerns.

In the disclosed IC structure, the electronic die further includes various active and passive electronic devices, such as field-effect transistors (FETs), fin-like FETs (FinFETs), and other multi-gate devices. In some examples, the multi-gate devices include gate-all-around (GAA) devices. The photonic die further includes optical lenses, grating couplers, waveguides, and photodiodes. Especially, an optical lens is formed by patterning the interlayer dielectric (ILD) layer to form an open hole in the ILD layer; and filling in the open hole with a transparent material. The moisture may penetrate through the open hole to damage the integrated circuit. In the disclosed IC structure, a seal ring structure is formed to surround the optical lens to protect the IC structure so that the moisture cannot penetrate to the IC structure through an open hole during the fabrication and even after filling the open hole with transparent material (such as silicon oxide) during field operations. The seal ring structure may include one layer, two layers or even more layers to laterally surround the optical lens. The seal ring structure is simultaneously formed with an interconnect structure and includes conductive features distributed in multiple metal layers. The seal ring structure and the interconnect structure are embedded in an interlayer dielectric (ILD) structure. The ILD structure includes one or more etch stop layers having silicon nitride or silicon carbide, which absorbs light and therefore needs to be removed in the lens region. In some embodiments, the seal ring structure further includes one or more via hole embedded in the ILD structure and configured to release stress. The IC structure and the method making the same are collectively described below in detail.

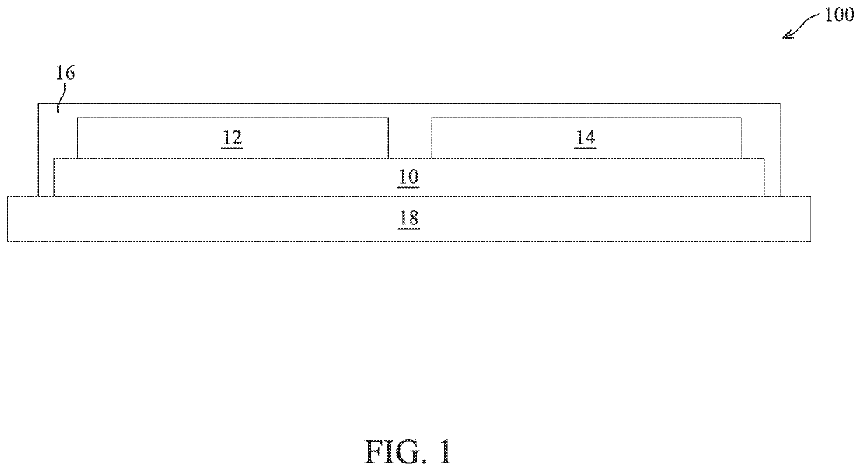

FIG. 1 is a schematic view of an IC structure 100 constructed in accordance with some embodiments. The IC structure 100 includes a substrate 10, such as a semiconductor substrate or other suitable substrate; a photonic die 12 and an electronic die 14 formed over the substrate 10 in the same packaging 16. In some embodiments, the packaged IC structure is amounted and connected to a printed circuit board (PCB) 18 or other suitable circuit board. In the described embodiments, the photonic die 12 and the electronic die 14 are formed in directly on the same substrate 10 or formed at different level in a 3D structure but in the same packaging 16. The electronic die 14 and the photonic die are co-packaged in a three-dimensional (3D) IC structure, such as chip-on-wafer (COW), chip-on-wafer-on-substrate (CoWoS), and other suitable 3D structure.

In the disclosed IC structure, the electronic die 14 further includes various active and passive electronic devices, such as FETs, FinFETs, and other multi-gate devices, such multi-gate devices include gate-all-around (GAA) devices. The photonic die further includes optical lenses, grating couplers or advanced coupler, waveguides, and photodiodes. In the disclosed embodiments, an optical lens is formed by patterning the interlayer dielectric (ILD) layer to form an open hole in the ILD layer; and filling in the open hole with a transparent material. Furthermore, a seal ring structure is formed to surround the optical lens to protect the IC structure so that the moisture cannot penetrate to the IC structure through an open hole during the fabrication and even after filling the open hole with transparent material during field operations. The seal ring structure may include one layer, two layers or even more layers to laterally surround the optical lens. The seal ring structure is simultaneously formed with an interconnect structure and includes conductive features distributed in multiple metal layers. The seal ring structure and the interconnect structure are embedded in an interlayer dielectric (ILD) structure. The ILD structure includes one or more etch stop layers having silicon nitride or silicon carbide. In some embodiments, the seal ring structure further includes one or more via hole embedded in the ILD structure and configured to release stress.

As the network speeds increased, so did the power and bandwidth used to reliably drive data signals over long runs of copper cable. This had brought a transition from copper to optical cabling for long runs because optical fiber offered less lossy transmission, higher bandwidth, and lower energy use. However, as data network speeds continue to increase, such as beyond 400 Gbps, the used power required to drive electrical signals even the relatively short distance from the switch circuit, such as switch application-specific integrated circuit (ASIC) on a printed circuit board (PCB) to ae pluggable modules at the front panel is becoming problematic. The disclosed IC structure with the photonic die 12 and the electronic die 14 formed in the same packaging overcome various issues including power efficiency and time delay. Especially, the seal ring structure configured surrounding the optical lens will protect the IC structure from moisture or other chemical penetration.

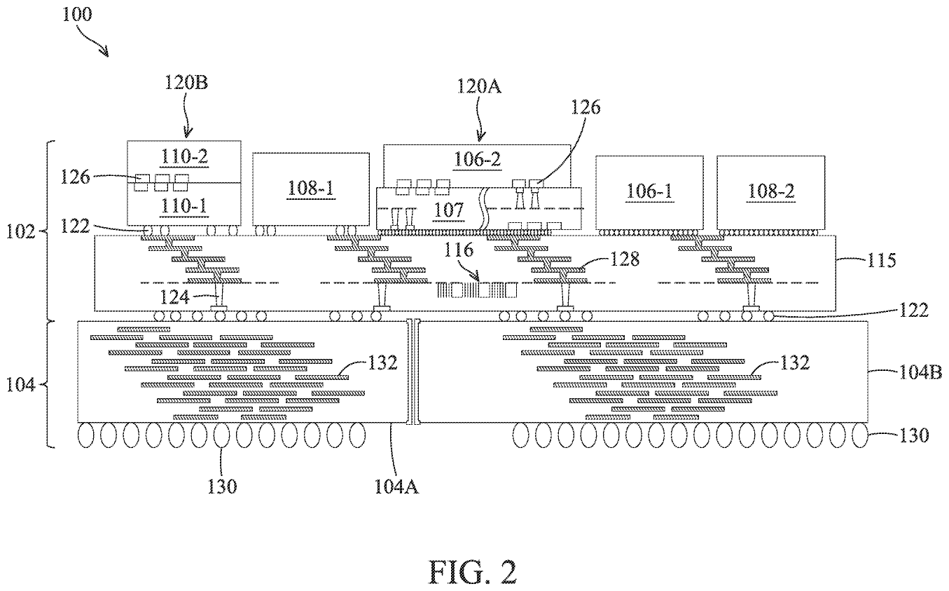

FIG. 2 is a fragmentary cross-sectional view of the IC structure 100, in portion or entirety, that is provided by arranging a chipset using a combination of multichip packaging technologies, such as chip-on-wafer-on-substrate (CoWoS) packaging technology, system-on-integrated-chips (SoIC) multi-chip packaging technology, an integrated-fan-out (InFO) package, according to various aspects of the present disclosure. It is noted that the IC structure 100 in FIG. 2 is only for illustration and IC structure 100 may have other structure such as other 3D structure. The IC structure 100, which can be referred to as a 3D IC package and/or a 3D IC module, includes a CoW structure 102 attached to a substrate 104 (e.g., a package substrate), which includes a package component 104A and a package component 104B in the depicted embodiment. CoW structure 102 includes a chipset (e.g., a core chip 106-1, a core chip 106-2, photonic chip 107, a memory chip 108-1, a memory chip 108-2, an input/output (I/O) chip 110-1, and an I/O chip 110-2 electrically connected to each other) attached to an interposer 115. The chipset is arranged into at least one chip stack, such as a chip stack 120A and a chip stack 120B. Chip stack 120A includes core chip 106-2 and photonic chip 107, and chip stack 120B includes I/O chip 110-1 and I/O chip 110-2. In the depicted embodiment, chips of chip stack 120A and chip stack 120B are directly bonded face-to-face and/or face-to-back to provide SoIC packages of multichip package. In some embodiments, a chip stack of multichip package includes a combination of chip types, such as a core chip having one or more memory chips disposed thereover. FIG. 2 has been simplified for the sake of clarity to better understand the inventive concepts of the present disclosure. Additional features can be added in multichip package, and some of the features described below can be replaced, modified, or eliminated in other embodiments of multichip package.

Core chip 106-1 and core chip 106-2 are central processing unit (CPU) chips and/or other chips. In some embodiments, core chip 106-1 is a CPU chip that forms at least a portion of CPU cluster, and core chip 106-2 is a GPU chip. In some embodiments, core chip 106-1 and core chip 106-2, or combinations thereof represent a stack of CPU dies, which can be bonded and/or encapsulated in a manner that provides a CPU package and/or a CPU-based SoIC package. In some embodiments, core chip 106-1 and core chip 106-2, or combinations thereof represent a stack of dies, which can be bonded and/or encapsulated in a manner that provides a GPU package and/or a SoIC package (e.g., a GPU-based SoIC package). In some embodiments, core chip 106-1, core chip 106-2, or combinations thereof represent a stack of CPU dies, which can be bonded and/or encapsulated in a manner that provides a core package and/or a core-based SoIC package. In some embodiments, core chip 106-1, core chip 106-2, or combinations thereof are SoCs.

Memory chip 108-1 and memory chip 108-2 are high bandwidth memory (HBM) chips, GDDR memory chips, dynamic random-access memory (DRAM) chips, static random-access memory (SRAM) chips, magneto-resistive random-access memory (MRAM) chips, resistive random-access memory (RRAM) chips, other suitable memory chips, or combinations thereof. In some embodiments, memory chip 108-1 and memory chip 108-2 are HBM chips that form at least a portion of the memory device. In some embodiments, memory chip 108-1 and memory chip 108-2 are a graphics double-data rate (GDDR) memory chips that form at least a portion of the memory device. In some embodiments, memory chip 108-1 is an HBM chip and memory chip 108-2 is a GDDR memory chip, or vice versa, that form at least a portion of the memory device. In some embodiments, memory chip 108-1 and/or memory chip 108-2 represent a stack of memory dies, which can be bonded and/or encapsulated in a manner that provides a memory package and/or a memory-based SoIC package. The memory package may be an HBM package (also referred to as an HBM cube) or a GDDR memory package.

Core chip 106-1, core chip 106-1 and photonic chip 107 (and thus chip stack 120A), memory chip 108-1, memory chip 108-2, and I/O chip 110-1 and I/O chip 110-2 (and thus chip stack 120B) are attached and/or interconnected to interposer 115. Interposer 115 is attached and/or interconnected to substrate 104. Various bonding mechanisms can be implemented in multichip package, such as electrically conductive bumps 122 (e.g., metal bumps), through semiconductor vias (TSVs) 124, bonding pads 126, or combinations thereof. For example, electrically conductive bumps 122 physically and/or electrically connect core chip 106-1, photonic chip 107 (and thus chip stack 120A), memory chip 108-1, memory chip 108-2, and I/O chip 110-1 (and thus chip stack 120B) to interposer 115. Electrically conductive bumps 122 and TSVs 124 physically and/or electrically connect interposer 115 to substrate 104. TSVs 124 of interposer 115 are electrically connected to electrically conductive bumps 122 of chips and/or chip stacks of CoW structure 102 through electrically conductive routing structures (paths) 128 of interposer 115. Bonding pads 126 physically and/or electrically connect photonic chip 107 and core chip 106-2 of chip stack 120A and I/O chip 110-1 and I/O chip 110-2 of chip stack 120B. Also, dielectric bonding layers adjacent to bonding pads 126 can physically contact photonic chip 107 and core chip 106-2 of chip stack 120A and/or I/O chip 110-1 and I/O chip 110-2 of chip stack 120B. In some embodiments, electrically conductive bumps 122 that connect chips and/or chip stacks to interposer 115 may be micro-bumps, while electrically conductive bumps 122 that connect interposer 115 to substrate 104 may be controlled collapse chip connections (referred to as C4 bonds) (e.g., solder bumps and/or solder balls).

In some embodiments, substrate 104 is a package substrate, such as coreless substrate or a substrate with a core, that may be physically and/or electrically connected to another component by electrical connectors 130. Electrical connectors 130 are electrically connected to electrically conductive bumps 122 of interposer 115 through electrically conductive routing structures (paths) 132 of substrate 104. In some embodiments, package component 104A and package component 104B are portions of a single package substrate. In some embodiments, package component 104A and package component 104B are separate package substrates arranged side-by-side. In some embodiments, substrate 104 is an interposer. In some embodiments, substrate 104 is a printed circuit board (PCB).

In some embodiments, interposer 115 is a semiconductor substrate, such as a silicon wafer (which may generally be referred to as a silicon interposer). In some embodiments, interposer 115 is laminate substrate, a cored package substrate, a coreless package substrate, or the like. In some embodiments, interposer 115 can include an organic dielectric material, such as a polymer, which may include polyimide, polybenzoxazole (PBO), benzocyclobutene (BCB), other suitable polymer-based material, or combinations thereof. In some embodiments, redistribution lines (layers) (RDLs) can be formed in interposer 115, such as within the organic dielectric material(s) of interposer 115. RDLs may form a portion of electrically conductive routing structures 128 of interposer 115. In some embodiments, RDLs electrically connect bond pads on one side of interposer 115 (e.g., top side of interposer 115 having chipset attached thereto) to bond pads on another side of interposer 115 (e.g., bottom side of interposer 115 attached to substrate 104). In some embodiments, RDLs electrically connect bond pads on the top side of interposer 115, which may electrically connect chips of the chipset. In the disclosed embodiment, one or more deep trench capacitor 116 may be embedded in interposer 115.

In some embodiments, multichip package can be configured as a 2.5D IC package and/or a 2.5D IC module by rearranging the chipset, such that each chip is bonded and/or attached to interposer 115. In other words, the 2.5D IC module does not include a chip stack, such as chip stack 120A and chip stack 120B, and chips of the chipset are arranged in a single plane. In such embodiments, core chip 106-3 and I/O chip 110-2 are electrically and/or physically connected to interposer by electrically conductive bumps 122.

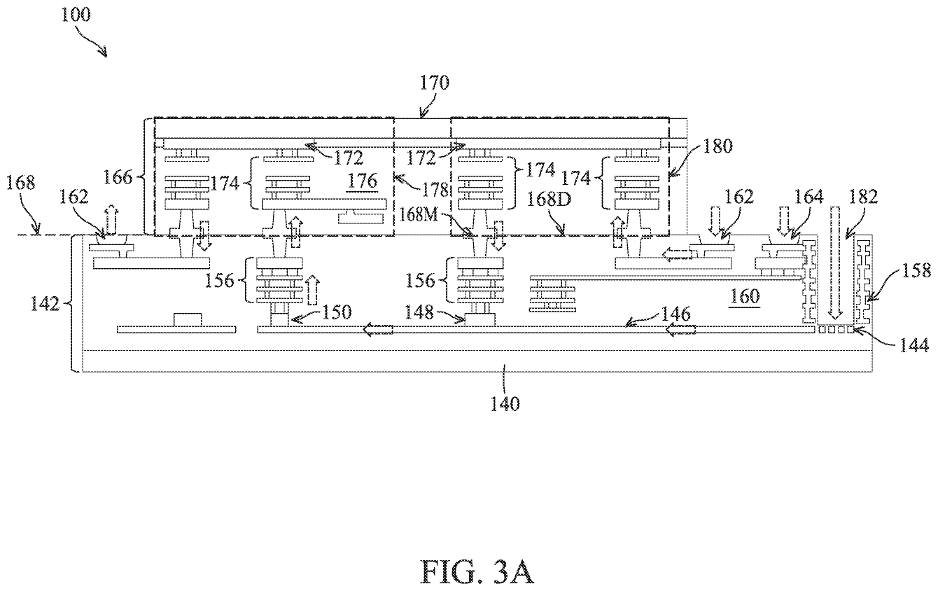

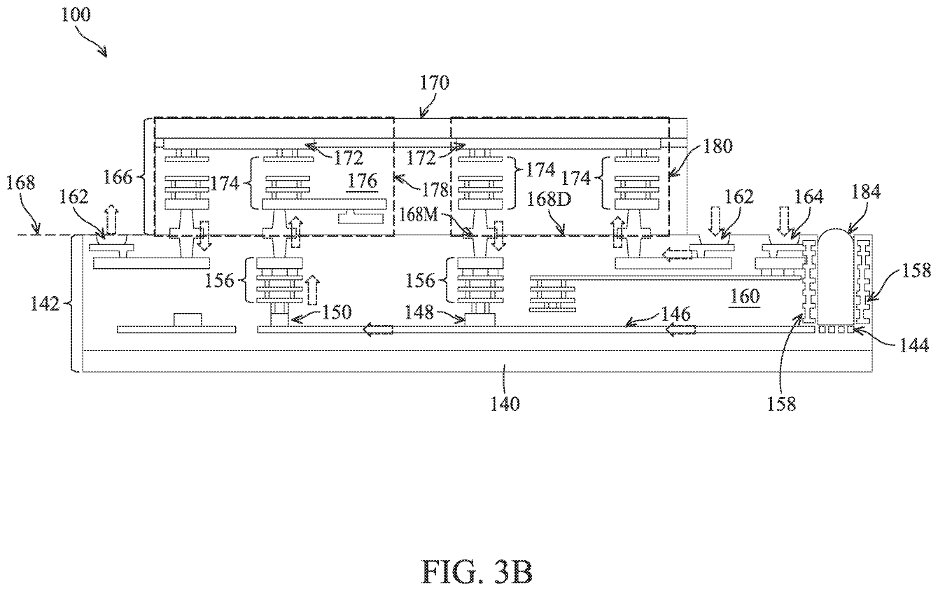

FIGS. 3A and 3B are fragmentary sectional views of the IC structure 100, in portion or entirety, at various fabrication stages, constructed in accordance with some embodiments of the present disclosure. FIG. 4 is a flowchart of a method 200 making the IC structure 100, constructed in accordance with some embodiments of the present disclosure. Particularly, the IC structure 100 includes photonic die and electronic die coupled and disposed in a same packaging. The IC structure 100 and the method 200 are collectively described with reference to FIGS. 3A, 3B and 4.

Referring to FIGS. 3A and 4, the method 200 begins at the block 202 by providing or receiving a substrate 140. In the disclosed embodiment, the substrate 140 is a silicon substrate, other semiconductor substrate, or other suitable substrate.

Still referring to FIGS. 3A and 4, the method 200 proceeds to an operation 204 to form a first IC chip (or a first die) 142 on the substrate 140. The first die 142 includes various components configured to a functional circuit and/or other functional modules. In some embodiments, the first die 142 is a photonic die. In some embodiments, the first die 142 includes a grating coupler (advanced coupler or any other suitable coupler) 144, a waveguide 146, and other devices, such as 148 and 150, integrated together and configured in series in a light path. The light is received by the first die 142 through an optical lens (which is to be described in FIG. 3B) in an optical lens region; focused on the coupler 144; coupled to the waveguide 146; and further processed through other components, such as converting the optical signal to an electrical signal. In some embodiments, those devices 148 and 150 configured in the light path may include a photodiode or other suitable devices configured to convert the received light into an electrical signal or process the received light otherwise.

Still referring to FIGS. 3A and 4, the method 200 proceeds to an operation 206 to form an interconnect structure 156 and a seal ring structure 158, such as by a procedure to simultaneously forming both the interconnect structure 156 and the seal ring structure 158. The interconnect structure 156 provide electrical routing and connection among various devices. For example, the interconnect structure 156 electrically couples various devices of the first die 142 to a second die 166 (that will be described later) so that the electrical signal is electrically transferred from the first die 142 to the second die 166. The interconnect structure 156 includes contacts, vias and metal lines distributed in multiple metal layers. In the illustrated embodiments, the interconnect structure 156 includes 4 metal layers (such as a first metal layer M1, a second metal layer M2, a third metal layer M3 and a fourth metal layer M4) with a plurality of metal lines distributed in these metal layers. However, it is understood that the interconnect structure 156 may include any suitable number of metal layers.

The seal ring structure 158 is similar to the interconnect structure 156 in terms of formation and composition but is configured and functions differently. For example, the seal ring structure 158 also includes contacts, vias and metal lines distributed in multiple metal layers. However, the seal ring structure is configured and designed to surround the optical lens region to protect the IC structure from moisture through the optical lens region. The seal ring structure 158 may include one layer or alternatively two layers, or even more layers to surround the optical lens region, thereby strengthening the sealing effect. For example, the seal ring structure 158 includes a first seal ring layer surrounding the optical lens region and a second seal ring layer laterally surrounding the first seal ring layer. In some embodiments, the spacing S1 between the seal ring structure and the optical lens ranges between 3 μm and 100 μm. In some embodiments, the spacing S2 between the first seal ring layer and the second seal ring layer is greater than S1, such as a ration S2/S1 ranging between 1.2 and 1.5. The interconnect structure 156 and the seal ring structure 158 are formed in an interlayer dielectric (ILD) structure 160. The ILD structure 160 is a dielectric structure and may include multiple ILD layers. In some embodiments, each ILD layer includes an etch stop layer and a bulk dielectric layer on the etch stop layer. The bulk dielectric layer includes silicon oxide, a low k dielectric material, other suitable dielectric materials, or a combination thereof. The etch stop layer includes silicon nitride or silicon carbide, which absorbs light and therefore is removed in the optical lens region at later stage. The ILD layers 160, the interconnect structure 156 and the seal ring structure 158 are formed by a proper procedure, such as damascene process. In some embodiments, the seal ring structure 158 may further include via holes in the ILD structure 160 configured to release the stress. In this case, a subset of the trenches and vias formed in the damascene process is not filled with metal. Instead, those are sealed by the overlying ILD layer to leave via holes in the ILD structure 160.

The first die 142 may further include other features, devices and components, such as a bond pad 162 (e.g., an aluminum pad), to receive electrical signal or couple to an outer circuit structure (e.g., a printed circuit board).

Still referring to FIGS. 3A and 4, the method 200 proceeds to an operation 208 to form a second IC chip (or a second die) 166 on the substrate 140. In the disclosed embodiment, the second die 166 is an electronic die. In the disclosed embodiment, the second die 166 is stacked on and bonded with the first die 142, resulting in a three-dimensional (3D) IC structure. The bonding interface 168 between the first die 142 and the second die 166 can be any suitable bonding mechanism to provide mechanical bonding and electrical routing therebetween. In some embodiments, the bonding interface 168 is a hybrid bonding and includes both dielectric bonding interface 168D and metal bonding interface 168M. In the furtherance of the embodiments, the second die 166 and the first die 142 are bonded through a frontside-to-frontside mode. For example, the first die 142 is formed on the substrate 140 and the second die 166 is formed on another substrate 170. Thereafter, the second die 166 and the first die 142 are bonded together frontside to frontside with a bonding interface 168.

The second die 166 includes various devices 172 formed on the substrate 170, and an interconnect structure 174 that is formed over the devices 172, is embedded in an ILD structure 176, and is coupling the devices 172 into an integrated circuit. For example, the integrated circuit in the second die 166 includes a first module 178 having a first function and a second module 180 having a second function different from the first function. The two modules of the second die 166 are integrated and are further coupled with the first die 142. The second die 166 may further include other devices, features and components. The interconnect structure 174 and the ILD structure 176 are similar to the interconnect structure 156 and the ILD structure 160 in terms of structure, composition and formation. For example, the interconnect structure 174 and the ILD structure 176 may be formed by damascene process as well. However, the interconnect structure 174 may be designed with a different number of metal layers. As an example, the interconnect structure 174 includes 12 or 13 metal layers.

Still referring to FIGS. 3A and 4, the method 200 proceeds to an operation 210 to pattern the ILD structure 160 to form an open hole 182 in the ILD structure 160 within the optical lens region. The patterning method includes a lithography process and etch. In the disclosed embodiments, the coupler 144 may be exposed within the open hole 182 or at most separated by a transparent material such as silicon oxide.

Referring to FIGS. 3B and 4, the method 200 proceeds to an operation 212 to fill in the open hole with a transparent material, thereby forming an optical lens 184 therein. In the present embodiment, silicon oxide is filled in the open hole 182 to form the optical lens 184. In some embodiments, the optical lens 184 includes a curved top surface to focus the light toward to the coupler 144. The optical lens 184 may be formed by a proper process, such as deposition by chemical vapor deposition (CVD), flowable CVD (CVD), other suitable method or a combination thereof. The method may further include an etching process designed to etch the deposited silicon oxide with desired top curved surface. In some other embodiments, the transparent material filled in the open hole 182 functions as an open area for light path, and a lens is additionally formed on the transparent material with curved shape. The lens and transparent open area are collectively referred to as an optical lens. The method may further include other fabrication processes 214 before, during or after the above operations.

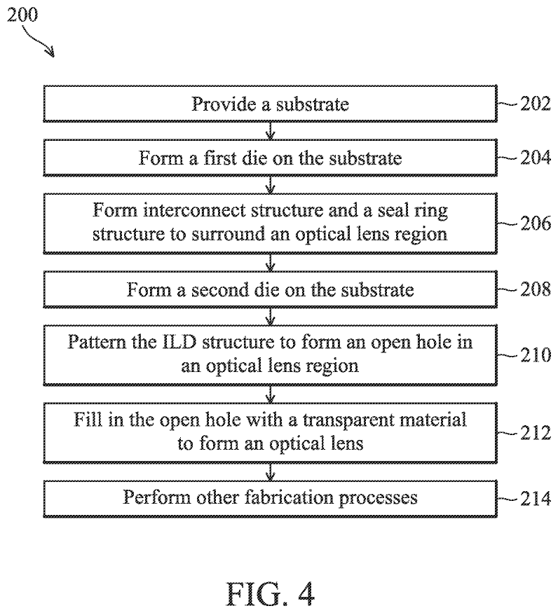

FIG. 5 is a fragmentary sectional view of the IC structure 300, in portion or entirety, constructed in accordance with some embodiments of the present disclosure. The IC structure 300 in FIG. 5 is similar to the IC structures in other figures. It includes a first die and a second die co-packaged on a same substrate and a seal ring structure is formed to surround the optical lens using the similar method such as the method 200. However, the IC structure 300 in FIG. 5 is configured in different 3D packaging structure. Especially, the IC structure 300 includes a first die and a second die integrated together and sealed in a same package. The IC structure 300 includes a first die 302, a second die 304, and a substrate (or another die) 306 integrated in a same package.

The first die 302 is formed on a first substrate 312. The first die 302 includes a lens open area dielectric feature 314 of silicon oxide, a grating coupler 316, a waveguide 318, and other components, such as a modulator and a detector properly configured and integrated. Particularly, the first die 302 includes a seal ring structure 326 surrounding the lens open area dielectric feature 314. The first die 302 includes an interconnect structure 324 that is simultaneously formed with the seal ring structure 326.

The second die 304 is formed on and bonded with the first die 302, such as hybrid bonding with frontside-to-frontside bonding interface. The second die 304 includes various devices 332 and an interconnect structure 344 electrically coupled to the devices 332. The second die 304 also includes a lens open area dielectric feature 334 of silicon oxide, and a lens 338 configured on the top of the lens open area dielectric feature 334. Especially, the lens open area dielectric feature 334 and the optical lens (or simply lens) 338 are aligned with the lens open area dielectric feature 314 to collectively form an optical lens coupled with the grating coupler (or an advanced coupler) 316. Particularly, the second die 304 also includes a seal ring structure 336 surrounding lens open area dielectric feature 334. The second die 304 also includes an interconnect structure 344 that are simultaneously and collectively formed with the seal ring structure 336. The lens 338 may include a curved surface, such as a convex surface, to focus the transmitted light into the grating coupler 316. In some embodiments, the lens 338 may include a material different from that of the lens open area dielectric feature 334, such as with different refractive index, so to reduce the reflection and enhance the transmission. In some embodiments, the lens 338 and the lens open area dielectric feature 334 may be designed to collectively function as an optical lens to effectively transmit the light on the grating coupler 316. The IC structure 300 may further include other structures, features and components, such as a backside interconnect structure including bond pads 348.

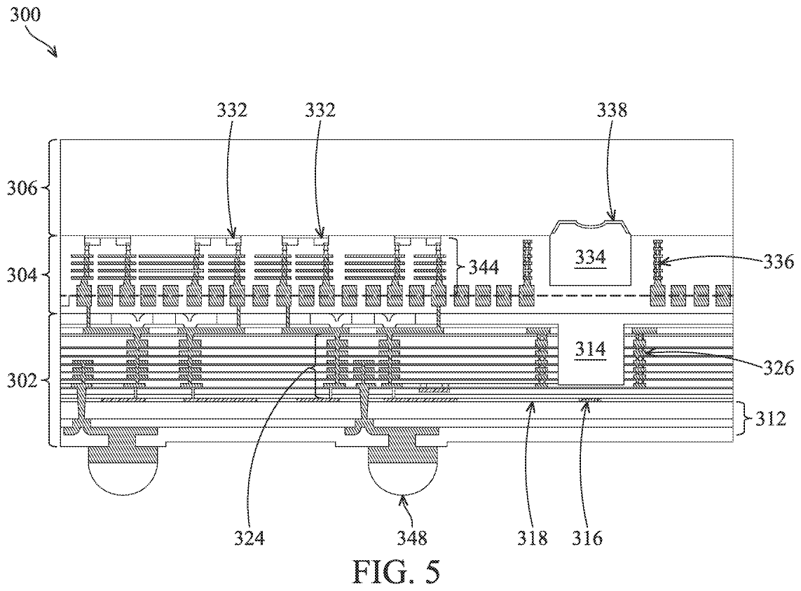

FIG. 6 is a fragmentary sectional view of the IC structure 350, in portion or entirety, constructed in accordance with some embodiments of the present disclosure. The IC structure 350 is similar to the IC structure 300 but have a chip-on-wafer (CoW) integration structure. Similar descriptions are not repeated here for simplicity. The IC structure 350 includes a first die 302, a second die 304 and another electronic die 306, and a support substrate 308 (such as silicon substrate) stacked and sealed in a same package.

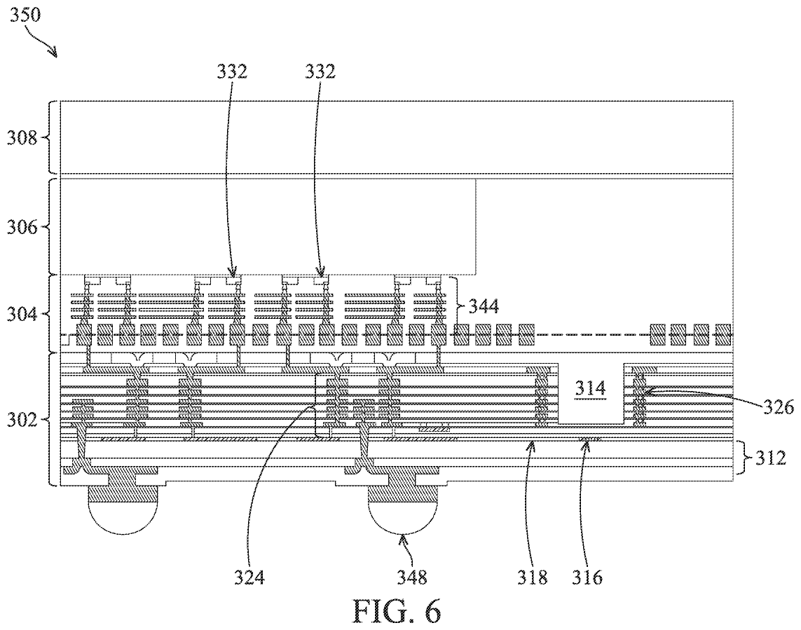

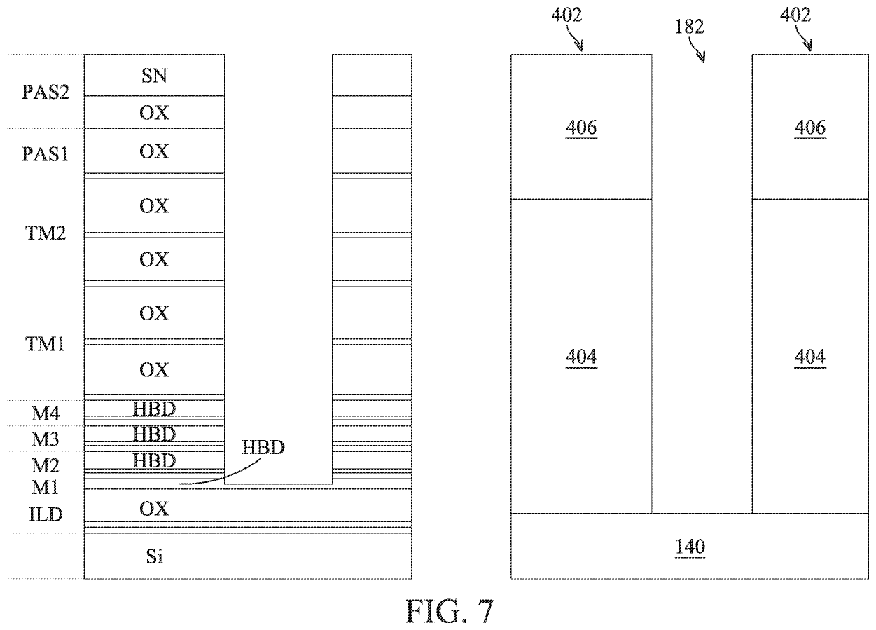

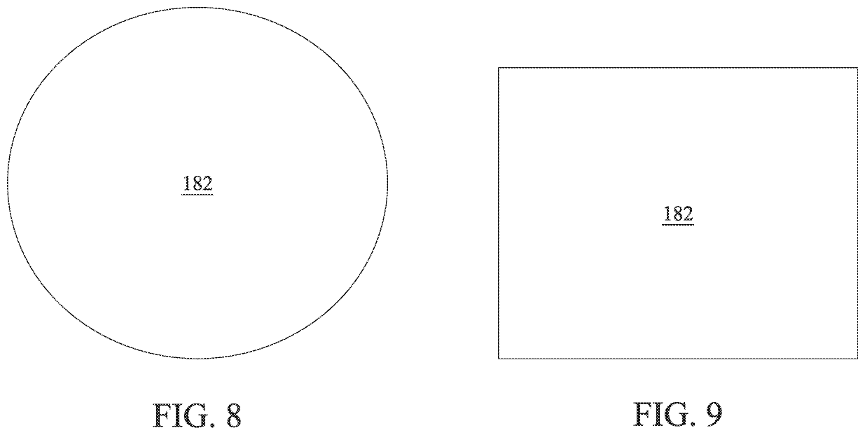

FIG. 7 is a sectional view of an IC structure (such as IC structures 100, 300, or 350), FIGS. 8 and 9 are top view of the IC structure, in portion, constructed in accordance with some embodiments of the present disclosure. Especially, the open hole in the lens region is illustrated. As described in the method 200, the optical lens is formed by patterning the ILD structure to form an open hole in the lens region, which is applicable to the IC structures 100, 300, and 350. The open hole in the lens region is further described with reference to FIGS. 7 through 9. The open hole 182 is formed within the lens region in the dielectric structure 402 over the substrate 140. In the disclosed embodiments, the dielectric structure 402 includes an ILD structure 404 and a passivation structure 406. As described above, the ILD structure 404 includes multiple layers with the interconnect structure and the seal ring structure embedded in. An ILD layer may include an a etch stop layer (such as silicon nitride or silicon carbide) and a bulk dielectric material layer such as silicon oxide, a low-k dielectric material, other suitable dielectric materials, or a combination thereof. The passivation structure 406 also includes various dielectric material layers for passivation/sealing and may include redistribution layer (RDL) and bond pads embedded therein and formed thereon. One example of the ILD structure 404 and the passivation structure 406 is illustrated on the left in FIG. 7. The passivation structure may include multiple passivation layers such as the first passivation layer (PAS1) and the second passivation layer (PAS2). Each passivation layer includes a silicon oxide (OX) film, a silicon nitride (SN) film or both. In the illustrated example, the ILD structure 404 includes multiple ILD layers with various metal lines and vias of the interconnect structure formed therein, respectively. In furtherance of the example, the metal lines of the interconnect structure are distributed in multiple metal layers and include first metal lines (M1), second metal lines (M2), third metal lines (M3), fourth metal lines (M4), first top metal lines (TM1) and second top metal lines (TM2). Each of the ILD layers includes a dielectric material layer, such as silicon oxide (OX), hard black diamond (HBD) or other suitable dielectric material. Each of the ILD layers may further include an etch stop layer disposed underlying respective dielectric material layer. The etch stop layer may include silicon nitride, silicon carbide, other suitable dielectric materials, or a combination thereof to achieve etch selectivity during etching of damascene processes. In the present example, the substrate 140 is a silicon (Si) substrate. The open hole 182 in the lens region may has any suitable shape, such a round shape as illustrated in FIG. 8, or alternatively square shape as illustrated in FIG. 9, or other suitable shape.

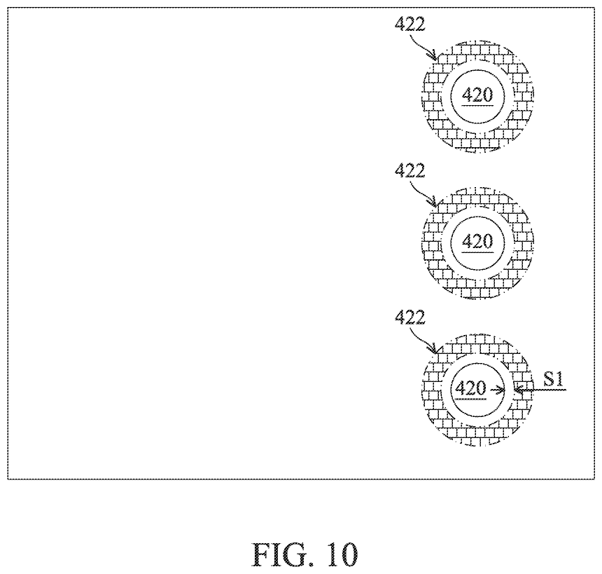

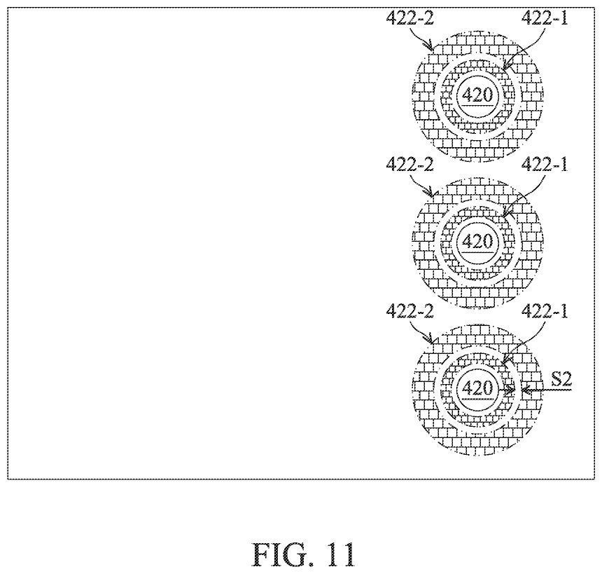

FIGS. 10 and 11 are top view of the IC structure (such as IC structures 100, 300, or 350), in portion, constructed in accordance with some embodiments of the present disclosure. Especially, the optical lens and the seal ring structure are illustrated. As described in the method 200, a seal ring structure 422 is formed to surround the optical lens open area, an open hole is formed in the optical lens open area, and an optical lens 420 is formed in the open hole, as illustrated in FIG. 10. The spacing S1 between the seal ring structure 422 and the optical lens 420 is designed in a proper range. Too small S1 may have risks of damaging the seal ring structure during the formation of open hole in the optical lens open area and destroying the protection of the seal ring structure 422. Too large S1 will occupy large circuit area, may be two close the edge of IC, may reduce the spacing between the seal ring structure 422 and the interconnect structure. In some embodiments, S1 ranges between 3 μm and 100 μm. The optical lens 420 includes the lens and the lens open area dielectric feature underlying the lens (such as those described in FIGS. 5 and 6), which provides a light path between the lens and the grating coupler (or an advanced coupler).

In some embodiments, the seal ring structure 422 includes two seal ring layers with a first seal ring layer 422-1 surrounding the optical lens 420 and a second seal ring layer 422-2 surrounding the first seal ring layer 422-1, as illustrated in FIG. 11. The two seal ring layers function as two walls to strengthen the protection of the IC structure from the moisture and other chemicals. The spacing S2 between the first seal ring layer 422-1 and the second seal ring layer 422-2 is greater than S1. In some embodiments, a ratio S2/S1 ranges between 1.2 and 1.5.

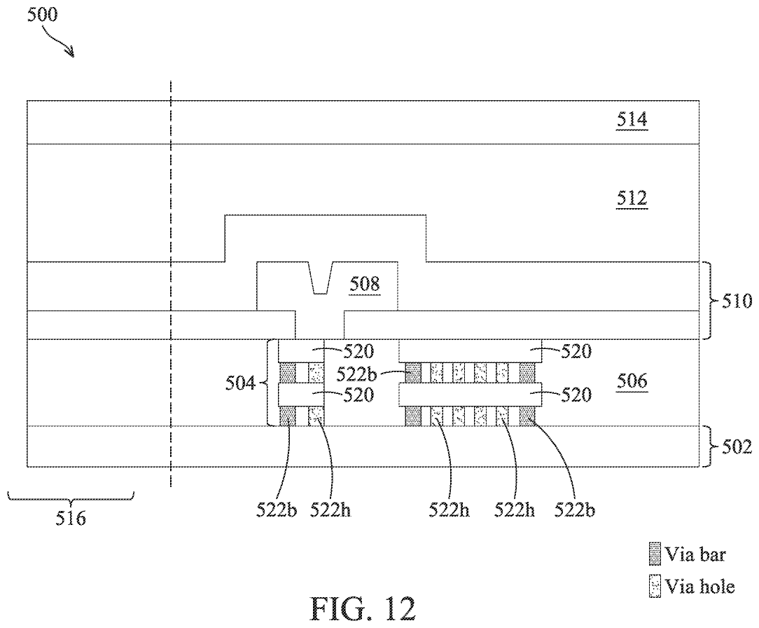

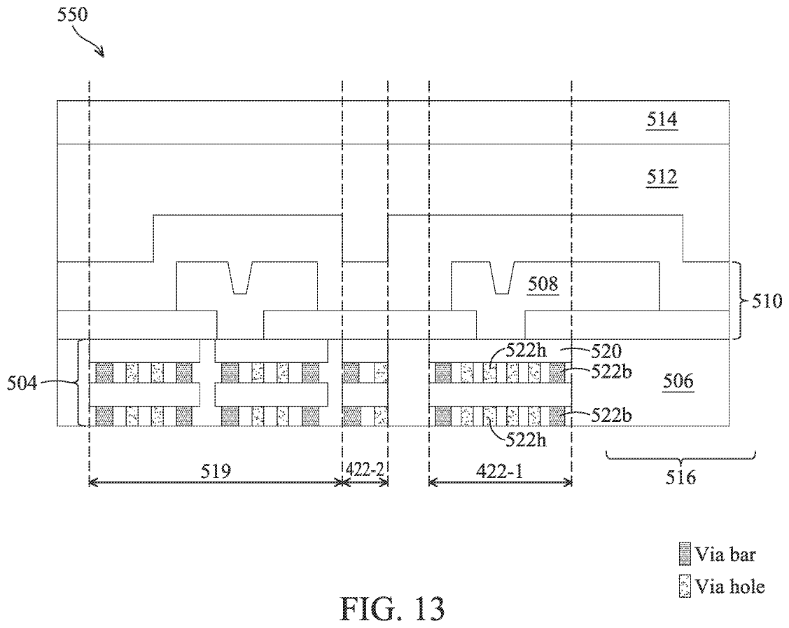

FIGS. 12 and 13 are sectional views of the IC structure (such as IC structures 100, 300, or 350), in portion, constructed in accordance with some embodiments of the present disclosure. Referring to FIG. 12, the IC structure 500 includes a substrate 502 and various device formed thereon. The IC structure 500 further includes an interconnect structure 504 formed in an ILD structure 506; and a redistribution layer (not shown) and bond pads 508 formed in the passivation structure 510. Especially, the interconnect structure 504 includes various conductive features (metal lines and vias) distributed in multiple metal layers. The passivation structure 510 may further include more than one passivation layer, such as a first passivation layer and a second passivation layer disposed on the first passivation layer. The IC structure 500 may further include other features such as dielectric layer 512 disposed on the passivation structure 510, and a bond film 514 disposed on the dielectric layer 512 to provide a bond surface so other die can be bonded thereon. The IC structure 500 includes various optical devices, such as grating couplers (or other advanced couplers), waveguides, photodiodes, and optical lens in the lens region. The IC structure 500 further includes a seal ring structure surrounding the optical lens in the lens region 516. Those features are illustrated in other figures (such as FIG. 13) and are not shown here for simplicity. The seal ring structure and the interconnect structure 504 both includes various metal lines 520 for horizontal routing and vias 522 for vertical routing. In some embodiments, the vias 522 include a first subset of via bars 522b as metal features and a second subset of via holes 522h as voids for proper functions, such as releasing the stress. Note the seal ring structure is not shown here but it is understood that the vias 522 in the seal ring structure also includes via bars 522b and via holes 522h as described above.

The IC structure 550 in FIG. 13 is similar to the IC structure 500 in FIG. 12. The IC structure 550 further illustrates the seal ring structure 422 with a first seal ring layer (or first seal ring wall) 422-1 and a second seal ring layer (or second seal ring wall) 422-2 configured to surround the optical lens in the lens region 516 and the first seal ring layer 422-1. As described above, the IC structure 550 is formed in a 3D packaging, such as chip-on-wafer and then separated into chips by scribing through the scribe region 519. The seal ring structure 422 includes metal lines 520 and vias 522. Furthermore, the vias 522 includes via bars 522b and via holes 522h as described above.

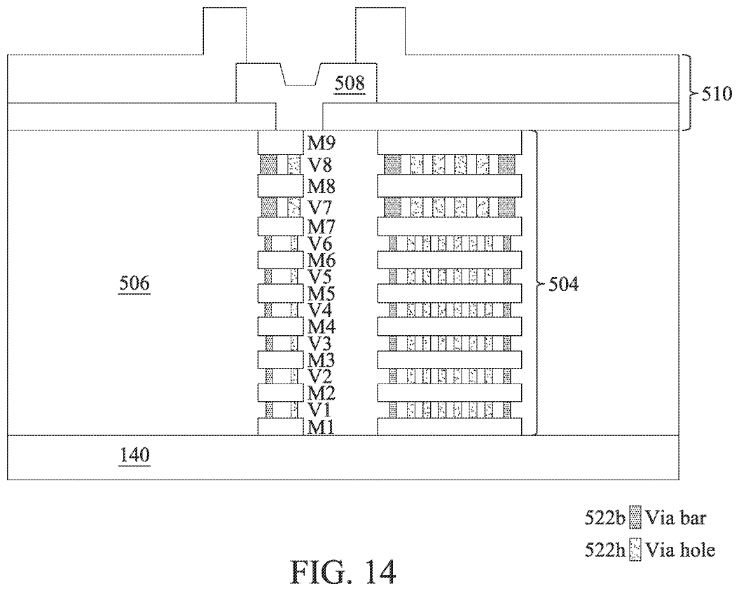

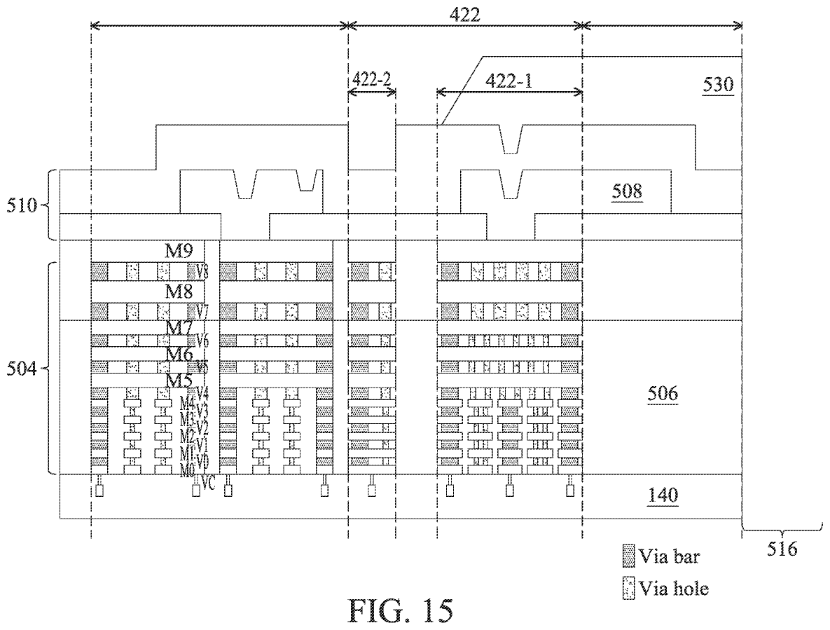

FIGS. 14 and 15 are sectional views of the IC structure, in portion, constructed in accordance with some embodiments of the present disclosure. The descriptions of similar features are not repeated for simplicity. The interconnect structure 504 is formed in the ILD structure 506 and includes contacts, vias and metal lines distributed in multiple metal layers such as 9 metal layers according to the illustrated example in FIG. 14. The interconnect structure 504 includes via bars and via holes as described above. The seal ring structure 422 is further illustrated in FIG. 15, in which the seal ring structure 422 includes a first seal ring wall 422-1 and a second seal ring wall 422-2 surrounding the optical lens in the lens region 516. In the disclosed embodiment, the second seal ring wall 422-2 spans a width less than that of the first seal ring wall 422-1. In an alternative embodiment, the second seal ring wall 422-2 spans a width greater than that of the first seal ring wall 422-1. The seal ring structure 422 includes via bars and via holes as described above.

The present disclosure provides an integrated circuit (IC) structure and a method making the same, and more particularly, to an integrated circuit structure having both electronic die and a photonic die formed in a same packaging. Especially, the photonic die further includes a lens and a transparent dielectric feature underlying the lens (collectively optical lens), and a seal ring structure formed to surround the optical lens. The optical lens is formed by patterning the interlayer dielectric (ILD) layer to form an open hole in the ILD layer; and filling in the open hole with a transparent material. A seal ring structure is formed to surround the optical lens to protect the IC structure so that the moisture cannot penetrate to the IC structure through an open hole during the fabrication and even after filling the open hole with transparent material (such as silicon oxide) during field operations. The seal ring structure may include one layer, two layers or even more layers to laterally surround the optical lens. The seal ring structure is formed before the open hole and may be simultaneously formed with an interconnect structure and includes conductive features distributed in multiple metal layers. The seal ring structure and the interconnect structure are embedded in an interlayer dielectric (ILD) structure. The ILD structure includes one or more etch stop layers having silicon nitride or silicon carbide, which absorbs light and therefore needs to be removed in the lens region. In some embodiments, the seal ring structure further includes one or more via hole embedded in the ILD structure and configured to release stress.

In one example aspect, the present disclosure provides an embodiment of a semiconductor device that comprises a first integrated circuit die disposed over a substrate; and a second integrated circuit die coupled with the first integrated circuit die and disposed over the substrate. The first integrated circuit die comprises an optical lens of a transparent material to receive light, and a seal ring structure surrounding the optical lens.

In another example aspect, the present disclosure provides an embodiment of a method of forming a semiconductor device, The method comprises forming a photonic integrated circuit over a substrate and having a lens region; forming a seal ring structure to surround the lens region; thereafter, forming an open hole in the lens region in an interlayer dielectric (ILD) structure; filling in the open hole with a transparent material; and forming an electronic integrated circuit over the substrate, wherein the electronic integrated circuit is coupled with the photonic integrated circuit.

In yet another example aspect, the present disclosure provides an embodiment of a method of forming a semiconductor device. The method comprises forming a photonic integrated circuit over a substrate and having a lens region; forming an interconnect structure and a seal ring structure, the seal ring structure being configured to surround the lens region; thereafter, forming an open hole in the lens region in an interlayer dielectric (ILD) structure; filling in the open hole with silicon oxide; and forming an electronic integrated circuit over the substrate, wherein the electronic integrated circuit is coupled with the photonic integrated circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device comprising:
a first die disposed over a substrate; and
a second die coupled with the first die and disposed over the substrate, wherein the first die comprises
an optical lens to receive light, and
a seal ring structure surrounding the optical lens.

2. The semiconductor device of claim 1, wherein
the optical lens comprises a vertical post of a transparent material on the substrate; and
the seal ring structure is laterally surrounding the vertical post.

3. The semiconductor device of claim 2, wherein a spacing between the optical lens and the seal ring structure ranges between 3 μm and 100 μm.

4. The semiconductor device of claim 2, wherein the seal ring structure comprises
a first seal ring layer laterally surrounding the vertical post; and
a second seal ring layer laterally surrounding the first seal ring layer.

5. The semiconductor device of claim 4, wherein each of the first and second seal ring layer comprises a conductive structure distributed through multiple metal layers of an interconnect structure.

6. The semiconductor device of claim 5, wherein the seal ring structure further comprises a via hole configured to release stress.

7. The semiconductor device of claim 2, wherein the vertical post of the optical lens has one of a square shape or a round shape in a top view.

8. The semiconductor device of claim 2, wherein
the first die further comprises a grating coupler; and
the vertical post of the optical lens comprises silicon oxide having a curved surface to focus the received light to the grating coupler.

9. The semiconductor device of claim 8, wherein the first die further comprises a waveguide and a photodiode configured on a light path of the received light.

10. A method of forming a semiconductor device, comprising:
forming a first integrated circuit over a substrate and having a lens region;
forming a seal ring structure to surround the lens region;
thereafter, forming an open hole in the lens region in an interlayer dielectric (ILD) structure;
filling in the open hole with a transparent material; and
forming a second integrated circuit over the substrate, wherein the second integrated circuit is coupled with the first integrated circuit.

11. The method of claim 10, further comprising forming an interconnect structure, wherein the interconnect structure and the seal ring structure are simultaneously formed.

12. The method of claim 11, wherein the forming the seal ring structure and the interconnect structure comprises
forming a first ILD layer;
forming first metal lines and first seal ring features in the first ILD layer;
forming a second ILD layer over the first ILD layer; and
forming second metal lines and second seal ring features in the second ILD layer, wherein the forming an open hole in the lens region includes forming the open hole through the first and second ILD layers.

13. The method of claim 12, wherein the forming the seal ring structure and the interconnect structure further comprises
forming a third ILD layer over the second ILD layer; and
forming third metal lines and third seal ring features in the third ILD layer, wherein the forming an open hole in the lens region comprises forming the open hole through the third ILD layer.

14. The method of claim 12, wherein each of the first and second ILD layers comprises an etch stop layer having silicon nitride or silicon carbide.

15. The method of claim 12, further comprising forming a grating coupler in the lens region, wherein the forming an open hole in the lens region comprises forming the open hole such that the grating coupler is exposed in the lens region.

16. The method of claim 12, wherein the filling in the open hole with a transparent material comprises filling in the open hole with silicon oxide.

17. The method of claim 10, wherein the forming a seal ring structure to surround the lens region further comprises simultaneously forming an interconnect structure, wherein each of the seal ring structure and interconnect structure comprises a conductive structure distributed through multiple metal layers.

18. The method of claim 17, wherein the forming a seal ring structure to surround the lens region further comprises forming a via hole in the ILD structure.

19. A method of forming a semiconductor device, comprising:
forming a first integrated circuit over a substrate and having a lens region;
forming an interconnect structure and a seal ring structure, the seal ring structure being configured to surround the lens region;
thereafter, forming an open hole in the lens region in an interlayer dielectric (ILD) structure;
filling in the open hole with silicon oxide; and
forming a second integrated circuit over the substrate, wherein the second integrated circuit is coupled with the first integrated circuit.

20. The method of claim 19, wherein the forming a seal ring structure to surround the lens region further comprises forming a via hole in the ILD structure.
